(19) United States
(12) Patent Application Publication
(10) Pub. No.: US 2013/0118163 A1
(43) Pub. Date: May 16, 2013

(54) FUEL INJECTION CONTROL DEVICE OF DIESEL ENGINE

(71) Applicant: Mazda Motor Corporation, Aki-gun (JP)

(72) Inventors: Hiroyuki Nishimura, Higashihiroshima-shi (JP); Keiji Araki, Hatsukaichi-shi (JP)

(73) Assignee: MAZDA MOTOR CORPORATION, Aki-gun (JP)

(21) Appl. No.: 13/633,755

(22) Filed: Oct. 2, 2012

(30) Foreign Application Priority Data
Nov. 16, 2011 (JP) 2011-250562

(51) Int. Cl. F01N 3/10; F02B 37/00; F02D 41/38

(52) U.S. Cl. 60/605.1; 60/299; 701/104

(57) ABSTRACT

A fuel injection control device of a diesel engine is provided. The device includes an engine body to be supplied with fuel mainly containing diesel fuel, a fuel injection valve for injecting the fuel into a cylinder of the engine body, a fuel injection control module for controlling the fuel injection by the fuel injection valve, and a catalyst for purifying HC provided in an exhaust passage through which exhaust gas is discharged from the cylinder. When the catalyst is in a deactivated state or the engine body is in a cold state, the fuel injection control module controls the fuel injection valve to perform a main injection for generating in the cylinder a main combustion mainly including a diffusion combustion, and a pre-injection for injecting the fuel before the main injection to generate a pre-combustion in the cylinder before the main combustion.

### BACKGROUND

The present invention belongs to a field of art relating to a fuel injection control device of a diesel engine.

In recent years, there has been a desire to reduce NOx generated by combustion in diesel engines installed in automobiles, and technical developments for the reduction have been advanced. As one of the techniques, reducing a geometric compression ratio of an engine has been performed to decrease combustion temperatures inside cylinders, so as to reduce NOx.

However, when a compression ratio of the engine is reduced, discharge amounts of HC and CO (raw HC and raw CO) from cylinders of the engine increase. Normally, a diesel engine is provided with an oxidation catalyst in its exhaust passage, and if the oxidation catalyst is in an activated state, HC and CO discharged from cylinders are purified by being oxidized through the oxidation catalyst without causing a problem even if the discharge amounts of HC and CO from the cylinders increase. However, if a period in which the oxidation catalyst is in a deactivated state exists, such as immediately after an engine start, and the period of the deactivated state is long, correspondingly large amounts of HC and CO will be discharged to the atmosphere.

Thus, it is required to promptly increase a temperature of the oxidation catalyst to an activating temperature. However, in this case, the combustion temperature becomes low due to the reduced compression ratio, causing a difficulty in the prompt increase of the temperature of the oxidation catalyst. Especially, if a turbine of a turbocharger for turbocharging intake air into the cylinders is arranged at an upstream side of the oxidation catalyst in an exhaust passage of the engine, the prompt increase of the temperature of the oxidation catalyst becomes more difficult.

Here, JP2007-154824A (paragraph [0042] and FIG. 5) discloses a spark-ignition engine where a temperature of exhaust gas (a temperature of a catalyst) is increased by combusting fuel with a main injection and an operation of an ignition plug immediately before a top dead center (TDC) on compression stroke, then performing a sub-injection (after injection) at such timing on an expansion stroke so that the fuel is ignited by the combustion heat, and further performing a sub-injection at such timing so that the fuel is ignited by the combustion heat of the fuel combusted by the sub-injection.

In order to activate the catalyst provided in the exhaust passage of the diesel engine promptly, it can be considered to perform a plurality of after injections after the main injection by using the technique of JP2007-154824A (paragraph [0042] and FIG. 5) applicable to the spark-ignition engine, so that the fuel combustion by the after injections (after combustion) occur consecutively to the fuel combustion by the main injection (main combustion). This is also effective in promptly activating the catalyst and transitioning the engine in a cold state to a warmed-up state even without reducing the compression ratio of the diesel engine.

However, with a diesel engine, because an ignition retardation period for fuel from the main injection is unstable, a timing at which the main combustion ends is unstable, and as a result, even if the first after injection is performed, the after combustion by the after injection becomes inconsecutive to the main combustion, and a possibility of the fuel discharged from the engine being unburnt becomes high. In this case, the temperature of the catalyst cannot be increased promptly, and also a large amount of unburnt HC will be discharged to the atmosphere. Therefore, in order to promptly activate the catalyst or change the engine to the warmed-up state, it is important to stabilize the ignition retardation period for fuel from the main injection.

### SUMMARY

The present invention is made in view of the above situations and aims to stabilize an ignition retardation period for fuel from a main injection as much as possible when a catalyst for purifying HC is in a deactivated state or an engine body is in a cold state.

According to one aspect of the invention, a fuel injection control device of a diesel engine is provided, which includes an engine body to be supplied with fuel mainly containing diesel fuel, a fuel injection valve for injecting the fuel into a cylinder of the engine body, a fuel injection control module for controlling the fuel injection by the fuel injection valve, and a catalyst for purifying HC, provided in an exhaust passage through which exhaust gas is discharged from the cylinder. When the catalyst is in a deactivated state or the engine body is in a cold state, the fuel injection control module controls the fuel injection valve to perform a main injection for generating in the cylinder a main combustion mainly including a diffusion combustion, and a pre-injection for injecting the fuel before the main injection to generate a pre-combustion in the cylinder before the main combustion. The main injection is performed at such timing that heat generation by the main combustion starts after a heat release rate caused by the pre-combustion passes its peak and before it reaches zero. The pre-injection is performed at such timing before a top dead center on compression stroke that the main injection is performed after the compression top dead center.

According to this configuration, the main injection is performed when the temperature inside the cylinder is sufficiently increased by the pre-combustion. Thus, a ignition retardation period for fuel from the main injection stabilizes and a timing at which the main combustion ends also stabilizes. As a result, when a temperature of the exhaust gas is increased so that an after combustion caused by an after injection is consecutive to the main combustion, the after combustion can surely continue consecutively to the main combustion. Therefore, when the catalyst is in the deactivated state, the catalyst can promptly be activated by the after injection, and when the engine body is in the cold state, the engine body can be transited into a warmed-up state promptly by the after injection.

A geometric compression ratio of the engine body may be 15:1 or below.

Thus, raw NOx to be discharged from the cylinder can be reduced. On the other hand, by such a low compression ratio, the ignition retardation period for fuel from the main injection becomes more unstable and a combustion temperature decreases, and thus, the prompt increase of the temperature of the catalyst and the prompt transition of the engine body to the warmed-up state become difficult. However, in the invention, even when the geometric compression ratio is 15:1 or below, the ignition retardation period for fuel from the main injection can be stabilized by the pre-injection, and further the after combustion can surely be consecutive to the main combustion. Therefore, the temperature of the exhaust gas to be discharged from the cylinder can be increased and, thus, the catalyst in the deactivated state can be activated promptly and the engine body can promptly be transited into the warmed-up state.

The fuel injection control device of a diesel engine may further include a temperature calculating module for calculating a temperature inside the cylinder at the compression top dead center. The fuel injection control module may increase an injection amount of the pre-injection or advances an injection timing of the pre-injection as the temperature calculated by the temperature calculating module is lower.

Thus, the timing at which the pre-combustion occurs and the heat release rate caused by the pre-combustion can be stabilized regardless of the temperature inside the cylinder at the compression top dead center (especially intake air temperature), and as a result, the ignition retardation period for fuel from the main injection can be stabilized regardless of the temperature inside the cylinder at the compression top dead center (especially intake air temperature).

When the catalyst is in the deactivated state, the fuel injection control module may control the fuel injection valve to perform, in addition to the pre-injection and the main injection, an after injection for injecting the fuel after the main injection to generate an after combustion in the cylinder consecutively to the main combustion.

By such an after injection, the temperature of the exhaust gas to be discharged from the cylinder can be increased and the catalyst in the deactivated state can be promptly activated. Moreover, due to the stabilization of the ignition retardation period for fuel from the main injection, the after combustion caused by the after injection can surely be consecutive to the main combustion and the generation of unburnt HC can be suppressed.

The fuel injection control device of a diesel engine may further include a turbocharger including a compressor arranged in an intake passage where an air intake into the cylinder is performed and a turbine arranged in the exhaust passage on an upstream side of the catalyst, to turbocharge intake air into the cylinder.

When the turbine is arranged in the exhaust passage upstream of the catalyst, if unburnt HC is generated, soot and unburnt HC become tarry and may attach to the turbine. However, in the invention, by the stabilization of the ignition retardation period for fuel from the main injection, the after combustion caused by the after injection can surely be consecutive to the main combustion, and the generation of unburnt HC can be suppressed. Thus, defects in the turbine due to the unburnt HC can be prevented. Moreover, the temperature of the exhaust gas tends to be decreased by the time it reaches the catalyst due to the intervention of the turbine. However, in the invention, the temperature of the exhaust gas to be discharged from the cylinder can be increased. In this manner, even with the intervention of the turbine, the temperature of the exhaust gas when it reaches the catalyst can remain high, and the catalyst in the deactivated state can be activated promptly.

The catalyst may be an oxidation catalyst, and, for a predetermined period of time after the catalyst becomes an activated state, the fuel injection control module may control the fuel injection valve to perform the main injection for generating in the cylinder the main combustion, mainly including the diffusion combustion, and a post injection for injecting the fuel after the main injection to supply unburnt fuel to the catalyst.

Thus, with the post injection, by using heat of an oxidizing reaction of unburnt fuel caused by the activated oxidation catalyst, the temperature of the activated oxidation catalyst can be maintained above the activating temperature.

### BRIEF DESCRIPTION OF THE DRAWINGS

FIG. 1 is a schematic diagram illustrating a configuration of a fuel injection control device of a diesel engine according to an embodiment of the invention.

FIG. 2 is a block diagram illustrating a configuration of a control system of the fuel injection control device.

FIG. 3 is a chart illustrating an example of a fuel injection mode controlled by a PCM when an oxidation catalyst is in a deactivated state.

FIG. 4 is a chart illustrating a change of a heat release rate inside a cylinder associated with the fuel injection mode in FIG. 3.

FIG. 5 is a chart illustrating another example of the fuel injection mode controlled by the PCM when the oxidation catalyst is in the deactivated state.

FIG. 6 is a chart illustrating an example of the fuel injection mode in an idling state controlled by the PCM when the oxidation catalyst is in an activated state.

FIG. 7 is a P-V graph in the idling state of the diesel engine when the oxidation catalyst is in the deactivated state (with after injections) and when the oxidation catalyst is in the activated state (without after injections).

FIG. 8 is a chart illustrating a relation of, in the diesel engine, a staged number of after injections (between four to six stages) with a temperature of exhaust gas at an inlet of an exhaust passage and the temperature of the exhaust gas at an inlet of the oxidation catalyst.

FIG. 9 is a chart illustrating a change with time of, when starting the diesel engine, the temperature of the exhaust gas at the exhaust passage inlet, the temperature of the exhaust gas at the oxidation catalyst inlet, an HC discharge amount (discharge amount of HC to the atmosphere per unit of time), and a CO discharge amount (discharge amount of CO to the atmosphere per unit of time).

### DETAILED DESCRIPTION OF THE EMBODIMENTS

Hereinafter, an embodiment of the present invention is described in detail with reference to the appended drawings.

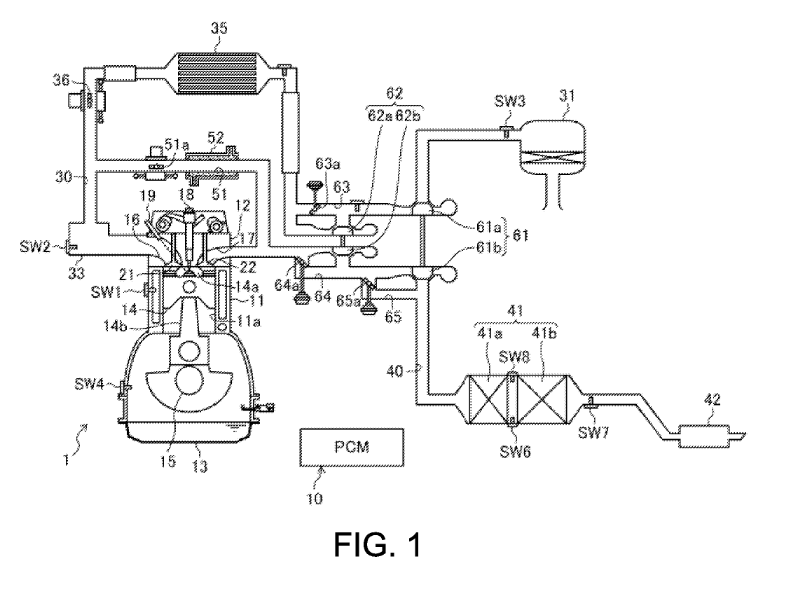

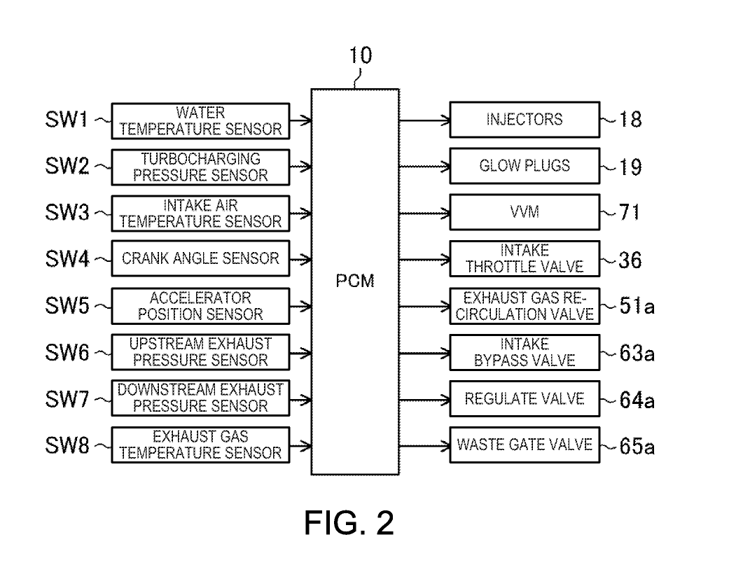

FIGS. 1 and 2 schematically illustrate a fuel injection control device of a diesel engine according to the embodiment of the invention. This fuel injection control device includes a diesel engine (hereinafter, referred to as the engine) 1 and a power train control module (hereinafter, referred to as the PCM) 10 for performing various controls including a fuel injection control by injectors 18 of the engine 1 described later. The PCM 10 configures a fuel injection control module in the claims.

The engine 1 is installed in a vehicle, such as an automobile, and a crankshaft 15 serving as an output shaft of the engine 1 is coupled to driving wheels via a transmission (not illustrated). An output of the engine 1 is transferred to the driving wheels to drive the vehicle.

The engine 1 (engine body) includes a cylinder block 11 formed with a plurality of cylinders 11a (only one cylinder is illustrated), a cylinder head 12 arranged on the cylinder block 11, and an oil pan 13 arranged below the cylinder block 11 and where a lubricant is stored. Inside each cylinder 11a of the engine 1, a piston 14 is reciprocatably fitted, and a cavity 14a partitionally forming a reentrant-shaped combustion chamber is formed on a crown surface (top face) of the piston 14 within a central axis of the cylinder 11a. The cavity 14a is tapered in its diameter toward an opening end. The piston 14 is coupled to a crank shaft 15 via a connecting rod 14b.

In the cylinder head 12, an intake port 16 and an exhaust port 17 are formed, and an intake valve 21 for opening and closing the opening of the intake port 16 on the combustion chamber side and an exhaust valve 22 for opening and closing the opening of the exhaust port 17 on the combustion chamber side are arranged for each cylinder 11a.

Within a valve train system of the engine 1 for operating the intake and exhaust valves 21 and 22, a hydraulically-actuated variable valve mechanism (hereinafter, referred to as a VVM (Variable Valve Motion)) 71 for switching an operation mode of the exhaust valve 22 between a normal mode and a special mode is provided on an exhaust valve 22 side (illustrated only in FIG. 2). The VVM 71 (a detailed configuration is not illustrated) is configured to include two kinds of cams with cam profiles different from each other in which a first cam has one cam nose and a second cam has two cam noses; and a lost motion mechanism for selectively transmitting an operation state of either one of the first and second cams to the exhaust valve 22. When the lost motion mechanism transmits the operation state of the first cam to the exhaust valve 22, the exhaust valve 22 operates in the normal mode where it opens only once during an exhaust stroke. On the other hand, when the lost motion mechanism transmits the operation state of the second cam to the exhaust valve 22, the exhaust valve 22 operates in the special mode where it opens once each during the exhaust stroke and intake stroke, that is, the exhaust valve opens twice in one cycle of the engine.

The normal and special modes of the VVM 71 are switched therebetween by a hydraulic pressure supplied from a hydraulic pressure pump operated by the engine (not illustrated), and the special mode is utilized in a control related to an internal EGR. Note that, an electromagnetically-operated valve system for operating the exhaust valve 22 by using an electromagnetic actuator may be adopted in enabling the switch between the normal and special modes. Further, the execution of the internal EGR is not limited to opening the exhaust valve twice, and it may be accomplished through, for example, an internal EGR control by opening the intake valve 21 twice or through an internal EGR control where burnt gas is left in the cylinder 11a by setting a negative overlap period in which both of the intake and exhaust valves 21 and 22 are closed during the exhaust stroke or the intake stroke.

The engine 1 (engine body) is supplied with fuel containing diesel fuel as its main component, from a fuel tank by a fuel pump (not illustrated). The cylinder head 12 is provided with the injectors 18 (fuel injection valves) for injecting the fuel into the cylinders 11a, respectively. Each injector 18 is arranged on a central axis of the cylinder 11a, and a fuel injection port formed in its tip (lower end) is exposed within the cavity 14a (combustion chamber) of the piston 14 when the piston 14 is positioned at a top dead center (TDC). The fuel is injected to spread in a hollow cone shape centering on the central axis of the cylinder 11a from the fuel injection port of the injector 18. If the fuel is injected from the injector 18 when the piston 14 is within a predetermined angle range of a crank angle with respect to the TDC on compression stroke (CTDC), the injected fuel will be supplied into the cavity 14a without touching a lip part, and if the fuel is injected from the injector 18 when the piston is above the predetermined angle range, the injected fuel will basically be supplied outside the cavity 14a.

Further, the cylinder head 12 is provided with glow plugs 19 for enhancing ignitability of the fuel by heating intake air inside the cylinders 11a respectively when the engine 1 (engine body) is in a cold state (when a temperature of an engine coolant detected by a water temperature sensor SW1, described later, is below a predetermined reference temperature (e.g., 80° C.)).

An intake passage 30 where intakes into the cylinders 11a are performed is connected with a surface of the cylinder head 12 on the intake valve 21 side so as to communicate with the intake ports 16 of the cylinders 11a. On the other hand, an exhaust passage 40 through which exhaust gas from the cylinders 11a is discharged is connected with a surface of the cylinder head 12 on the exhaust valve 22 side so as to communicate with the exhaust ports 17 of the cylinders 11a. The intake and exhaust passages 30 and 40 are arranged with a large turbocharger 61 and a small turbocharger 62 for turbocharging the intake air (described later in details).

An air cleaner 31 for filtering intake air is arranged in an upstream end part of the intake passage 30. A surge tank 33 is arranged near a downstream end of the intake passage 30. A part of the intake passage 30 downstream of the surge tank 33 is branched toward the respective cylinders 11a to be independent passages, and downstream ends of the independent passages are connected with the intake ports 16 of the cylinders 11a, respectively.

A compressor 61a of the large turbocharger 61, a compressor 62a of the small turbocharger 62, an intercooler 35 for cooling air compressed by the compressors 61a and 62a, and an intake throttle valve 36 for adjusting an intake air amount for each cylinder 11a are arranged between the air cleaner 31 and the surge tank 33 in the intake passage 30 from its upstream side. The intake throttle valve 36 is basically fully opened or has an opening close thereto; however, it is fully closed when the engine 1 is stopped so as to avoid a shock. Moreover, when an oxidation catalyst 41a described later is in a deactivated state, the intake throttle valve 36 is below a predetermined opening (e.g., 20%). This is because, when the oxidation catalyst 41a is in the deactivated state, although a temperature of the exhaust gas is increased to promptly activate the oxidation catalyst 41a as described later, if a large amount of fresh air is supplied into the cylinder 11a, it is disadvantageous in increasing the exhaust gas temperature. Note that, setting the intake throttle valve 36 to have the opening below the predetermined opening is not essential.

An upstream part of the exhaust passage 40 is constituted with an exhaust manifold having independent passages branched toward the cylinders 11a respectively, and connected with outer ends of the exhaust ports 17, and a merging section where the independent passages merge together.

In a part of the exhaust passage 40 downstream of the exhaust manifold, a turbine 62b of the small turbocharger 62, a turbine 61b of the large turbocharger 61, turbine bypass passages 65 and 64 for bypassing the turbines 62b and 61b, an exhaust emission control system 41 for purifying hazardous components contained in the exhaust gas, and a silencer 42 are arranged from its upstream side in this order.

The exhaust emission control system 41 includes the oxidation catalyst 41a and a diesel particulate filter (hereinafter, referred to as the DPF) 41b arranged from its upstream side in this order. The oxidation catalyst 41a and the DPF 41b are accommodated in a single case. The oxidation catalyst 41a has an oxidation catalyst carrying only platinum or platinum added with palladium and the like, and promotes a reaction of oxidizing HC and CO contained within the exhaust gas to generate H₂O and CO₂. The oxidation catalyst 41a configures a catalyst for purifying HC in the claims. Further, the DPF 41b is a filter that captures particulates (PM), such as soot, which are contained in the exhaust gas of the engine 1, for example, the DPF 41b is a wall flow type filter formed with thermo resistant ceramic material such as silicon carbide (SiC) or cordierite, or a three-dimensional net filter formed with a thermo resistant ceramic fiber. Note that, the oxidation catalyst may be coated on the DPF 41b.

An exhaust gas recirculation passage 51 for re-circulating a part of the exhaust gas to the intake passage 30 connects a part of the intake passage 30 between the surge tank 33 and the intake throttle valve 36 with a part of the exhaust passage 40 between the exhaust manifold and the small turbine 62b of the small turbocharger 62. The exhaust gas recirculation passage 51 is arranged with an exhaust gas re-circulation valve 51a for adjusting a re-circulating amount of the exhaust gas to the intake passage 30 and an EGR cooler 52 for cooling the exhaust gas by the engine coolant.

The large turbocharger 61 has the large compressor 61a arranged in the intake passage 30 and the large turbine 61b arranged in the exhaust passage 40. The large compressor 61a is arranged in the intake passage 30 between the air cleaner 31 and the intercooler 35. On the other hand, the large turbine 61b is arranged in the exhaust passage 40 between the exhaust manifold and the oxidation catalyst 41a.

The small turbocharger 62 has the small compressor 62a arranged in the intake passage 30 and the small turbine 62b arranged in the exhaust passage 40. The small compressor 62a is arranged in the intake passage 30 upstream of the intercooler 35 and downstream of the large compressor 61a. On the other hand, the small turbine 62b is arranged in the exhaust passage 40 downstream of the exhaust manifold and upstream of the large turbine 61b. The large and small turbines 61b and 62b are arranged in the intake passage 30 upstream of the oxidation catalyst 41a.

The large compressor 61a and the small compressor 62a are aligned in the intake passage 30 in this order from the upstream side, and the small turbine 62b and the large turbine 61b are aligned in the exhaust passage 40 in this order from the upstream side. These large and small turbines 61b and 62b are rotated by an exhaust gas flow, and the large and small compressors 61a and 62a respectively coupled to the large and small turbines 61b and 62b turbocharge intake air by being operated with the rotations of the large and small turbines 61b and 62b.

The small turbocharger 62 is relatively small, and the large turbocharger 61 is relatively large. Thus, the large turbine 61b of the large turbocharger 61 has a larger inertia than the small turbine 62b of the small turbocharger 62.

Further, a small intake bypass passage 63 for bypassing the small compressor 62a is connected with the intake passage 30. This small intake bypass passage 63 is arranged with a small intake bypass valve 63a for adjusting an air amount that flows into the small intake bypass passage 63. The small intake bypass valve 63a is configured to be fully closed (normally closed) when there is no power distribution.

The engine 1 configured as above is controlled by the PCM 10. The PCM 10 is configured by a microprocessor having a CPU for executing a program, a memory for storing a program and data, a set of counter timers, an interface, and a pass for connecting these units.

As illustrated in FIG. 2, the PCM 10 is inputted with detection signals of the water temperature sensor SW1 for detecting the temperature of the engine coolant, a turbocharging pressure sensor SW2 attached to the surge tank 33 and for detecting a pressure of air to be supplied into the cylinders 11a, an intake air temperature sensor SW3 for detecting the temperature of intake air (intake air temperature), a crank angle sensor SW4 for detecting a rotational angle of the crankshaft 15, an accelerator position sensor SW5 for detecting an accelerator opening amount corresponding to an angle of an acceleration pedal (not illustrated) of the vehicle, an upstream exhaust pressure sensor SW6 for detecting an exhaust gas pressure on the upstream of the DPF 41b, a downstream exhaust pressure sensor SW7 for detecting the exhaust gas pressure on the downstream of the DPF 41b, and an exhaust gas temperature sensor SW8 arranged between the oxidation catalyst 41a and the DPF 41b in the case accommodated therewith, and for detecting the temperature of the exhaust gas flown out of the oxidation catalyst 41a. By performing various kinds of operations based on these detection signals, the PCM 10 determines states of the engine 1 and the vehicle, and further outputs control signals to the injectors 18, the glow plugs 19, the VVM 71 in the valve train system, and actuators of the various kinds of valves 36, 51a, 63a, 64a, and 65a according to the determined states.

As a basic control of the engine 1, the PCM 10 determines a target torque (target load) based mainly on an engine speed obtained from the detection signal from the crank angle sensor SW4, and the accelerator opening amount detected by the accelerator position sensor SW5, and achieves the fuel injection amount and the injection timing corresponding to the target torque by operating the injectors 18. The target torque is set larger as the accelerator opening amount is larger and the engine speed is higher. The fuel injection amount is set based on the target torque and the engine speed. The fuel injection amount is set larger as the target torque is larger and the engine speed is higher.

Moreover, the PCM 10 controls a re-circulation ratio of the exhaust gas into the cylinders 11a by controlling the openings of the intake throttle valve 36 and the exhaust gas re-circulation valve 51a (external EGR control) or controlling the VVM 71 (internal EGR control).

The geometric compression ratio of the engine 1 is 15:1 or lower. Specifically, the geometric compression ratio is preferably between 12:1 and 15:1. With such a reduced compression ratio, raw NOx discharged from the cylinders 11a is reduced and a thermal efficiency is improved. On the other hand, with the engine 1, by increasing the torque with the above described large and small turbochargers 61 and 62, the reduced compression ratio due to the reduced geometric compression ratio is compensated. Further, although the discharge amounts of HC and CO (raw HC and raw CO) from the cylinders 11a increase due to the reduced compression ratio, HC and CO are oxidized to be purified by the oxidation catalyst 41a. Note that, when the oxidation catalyst 41a is in a deactivated state, because HC and CO are not purified, in this embodiment, the exhaust gas temperature is increased when the detected temperature from the exhaust gas temperature sensor SW8 is below a predetermined temperature (the temperature corresponding to an activating temperature of the oxidation catalyst 41a) so as to activate the oxidation catalyst 41a promptly as described later.

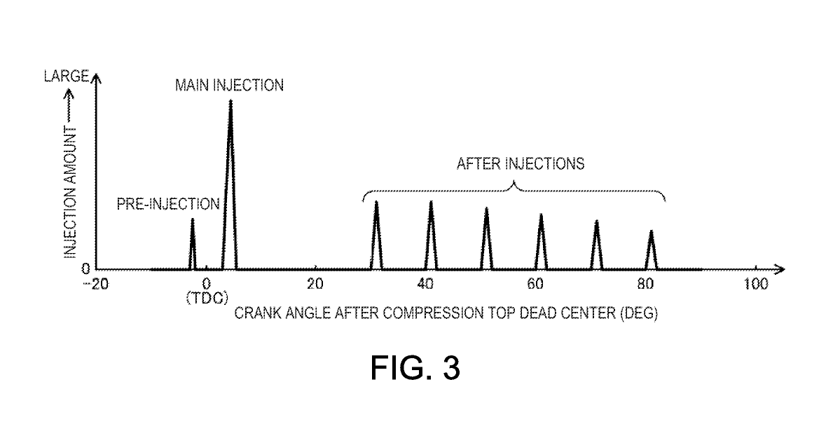

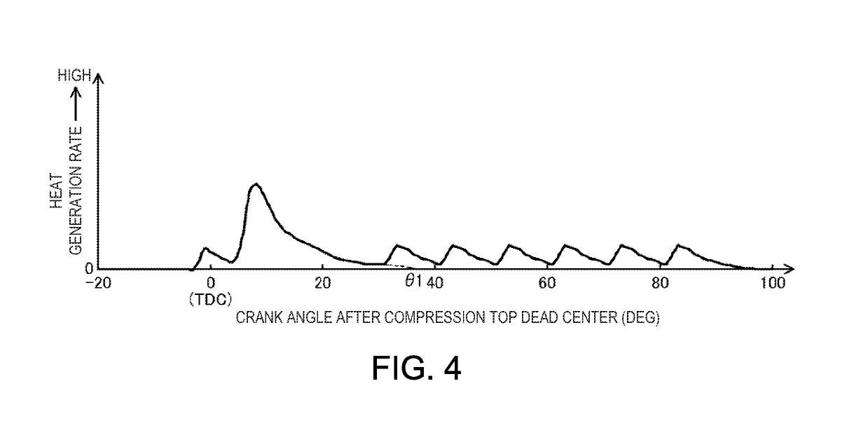

FIG. 3 illustrates a fuel injection mode controlled by the PCM 10 when the oxidation catalyst 41a is in the deactivated state. FIG. 4 illustrates a change of a heat release rate inside the cylinder 11a associated with the fuel injection mode (a change rate of the amount of heat generation inside the cylinder 11a with respect to the crank angle). When the detected temperature from the exhaust gas temperature sensor SW8 is below the predetermined temperature, the PCM 10 determines that the oxidation catalyst 41a is in the deactivated state, and when the detected temperature from the exhaust gas temperature sensor SW8 is above the predetermined temperature, the PCM 10 determines that the oxidation catalyst 41a is in an activated state.

When the oxidation catalyst 41a is in the deactivated state (when it is determined to be in the deactivated state based on the detected temperature from the exhaust gas temperature sensor SW8), the PCM 10 controls each injector 18 to perform a pre-injection, a main injection, and a plurality of after injections (six after injections in this embodiment).

The main injection causes within the cylinder 11a, a main combustion including mainly a diffusion combustion and for generating the engine torque, and the pre-injection causes a pre-combustion within the cylinder 11a before the main combustion and is for injecting the fuel into the cavity 14a before the main injection and the CTDC. The temperature inside the cylinder 11a (especially within the cavity 14a) is increased by the pre-combustion by the pre-injection and, by performing the main injection under the state with the increased temperature, a ignition retardation period for fuel from the main injection (here, a time period starting from the start of the main injection until a combusted mass ratio of the fuel due to the main injection becomes 10%) stabilizes.

To further stabilize the ignition retarded time period, the main injection is performed at such timing that heat generation by the main combustion starts after the heat release rate by the pre-combustion passes its peak and before it reaches zero. Thus, as illustrated in FIG. 4, the heat release rate within the cylinder 11a decreases after its first peak caused by the pre-combustion, starts to increase by the main combustion before reaching zero in the decrease, and then reaches its second peak significantly higher than the first peak.

Here, in the case where the main injection is performed at such timing that the heat generation by the main combustion starts before the heat release rate by the pre-combustion passes its peak, the main injection is performed before the fuel is efficiently combusted in the pre-injection, that is before the temperature inside the cylinder 11a (within the cavity 14a) efficiently increases, and as a result, the ignition retardation period for fuel from the main injection becomes unstable, causing a higher possibility of generating soot. On the other hand, in a case where the main injection is performed at such timing that the heat generation by the main combustion starts after the heat release rate by the pre-combustion reaches zero, the main injection is performed after the temperature inside the cylinder 11a (within the cavity 14a) starts to decrease, and as a result, the ignition retardation period for fuel from the main injection becomes unstable. However, by performing the main injection at such timing that the heat generation by the main combustion starts after the heat release rate passes its peak and before it reaches zero, the main injection is performed when the temperature inside the cylinder 11a (within the cavity 14a) is efficiently increased, and thus, the ignition retardation period for fuel from the main injection stabilizes. Note that the most suitable timing of performing the main injection is such timing that the heat generation by the main combustion starts when the combusted mass ratio of the fuel caused by the main injection becomes 85% or 95%.

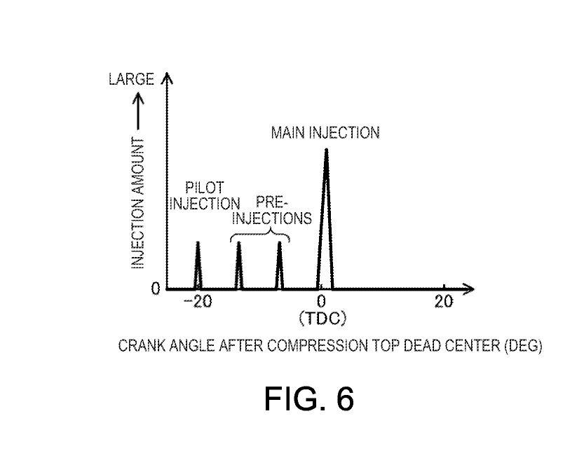

The pre-injection is performed at such timing before the CTDC and that the main injection is performed after the CTDC. Here, the main injection is preferred to be performed at or near the CTDC. To realize this, the pre-injection is performed before the CTDC so that the pre-combustion is generated at or near the CTDC. Further, in this embodiment, the main injection is performed after and near the CTDC (within the crank angle range of 7° after the CTDC) so that the combustion lasts as long as possible on the expansion stroke along with an after combustion consecutively to the main combustion (described later), and in FIG. 3, the main injection is performed at a timing slightly after a main injection when the oxidation catalyst 41a is in the activated state (main injection in FIG. 6, described later). Thus, the main injection is performed at a timing shortly before the CTDC.

In this embodiment, the PCM 10 calculates the temperature inside the cylinder 11a at the CTDC based on the intake air temperature detected by the intake air temperature sensor SW3 and an effective compression ratio, and as the calculated temperature inside the cylinder 11a at the CTDC is lower, the PCM 10 either increases the injection amount of the pre-injection or advances the injection timing of the main injection. Thus, the timing at which the pre-combustion is generated or the heat release rate by the pre-combustion can be stabilized regardless of the temperature inside the cylinder 11a at the CTDC (especially the intake air temperature), and as a result, the ignition retardation period for fuel from the main injection can be stabilized regardless of the same. Thus, the PCM 10 configures a temperature calculating module for calculating the temperature inside the cylinder 11a at the CTDC.

The plurality of after injections are for causing the after combustion consecutively to the main combustion inside the cylinder 11a to continue the combustion at least until the middle stage of the expansion stroke, in which the fuel is injected after the main injection. By such after injections, the temperature of the exhaust gas discharged from the cylinder 11a is increased to promptly activate the oxidation catalyst 41a in the deactivated state.

In the main injection and one or more of the plurality of after injections including at least the first after injection that are performed before the crank angle reaches the predetermined angle with respect to the CTDC, the fuel is injected into the cavity 14a, and the rest of the plurality of after injections performed after the crank angle reaches the predetermined angle with respect to the CTDC, the fuel is injected outside the cavity 14a. In this embodiment, the fuel is injected into the cavity 14a only in the first after injection, and the fuel is injected outside the cavity 14a in the rest of the after injections.

Because the main combustion by the main injection is basically generated within the cavity 14a, by injecting the fuel into the cavity 14a by the first after injection, the after combustion by the first after injection can easily be generated consecutively to the main combustion. The timing at which the first after injection is performed is arbitrary as long as the fuel can be injected into the cavity 14a and the after combustion is generated consecutively to the main combustion; however, if the timing of generating the after combustion is excessively early, the after combustion accordingly ends early, and therefore, it is preferable to delay the performance of the first after injection as much as possible to retard the timing at which the after combustion ends as much as possible. For example, the first after injection is preferred to be performed when the heat release rate caused by the main combustion reaches 1-2 J/deg. Thus, as illustrated in FIG. 4, the after combustion by the first after injection is generated (the heat generation by the after combustion starts) immediately before the heat release rate by the main combustion reaches zero (immediately before the main combustion ends). If the after combustion is not generated, the heat release rate decreases and reaches zero at a crank angle θ1 after the CTDC as indicated by the two-dot chain line in FIG. 4. However, with the after combustion, the combustion continues even after θ1, and the crank angle when the heat release rate becomes 0 can be retarded even more than θ1. Moreover, if the timing at which the after combustion is generated is excessively early, there is a possibility that the after combustion influences the engine torque, and a possibility becomes higher that a torque higher than the torque determined by the main combustion is generated and soot is generated. Also in view of suppressing these possibilities, the performance of the first after injection is preferred to be as late as possible.

Note that, because the ignition retardation period for fuel from the main injection is stabilized by the pre-injection, the timing at which the main combustion ends is also stable. Thus, even if the performance of the first after injection is delayed as much as possible, the after combustion by the first after injection will surely be consecutive to the main combustion.

A timing at which a second after injection is performed is basically similar to the relation between the main combustion and the after combustion by the first after injection, in which the second after injection is performed so that an after combustion by the second after injection is generated (a heat generation by the after combustion starts) before the after combustion by the first after injection ends. Even if the second after injection injects the fuel outside the cavity 14a, because the temperature inside the cylinder 11a is increased by the main combustion and the after combustion due the first after injection, the after combustion can continue by the second after injection, consecutively to the after combustion by the first after injection. Thus, in this embodiment, the combustion lasts until the middle stage of the expansion stroke by performing the after injection six times. Note that, if the generation of unburnt HC and unburnt CO can be suppressed, the combustion preferably lasts until the late stage of the expansion stroke.

The injection amount of the after injections is preferably large in view of increasing the temperature inside the cylinder 11a to last the combustion for a long time period. However, if the injection amount is excessively large, soot may be generated and unburnt fuel may be left and causes the generation of unburnt HC and unburnt CO. Therefore, the injection amount is preferably set to such amount that the injected fuel is completely combusted and soot, unburnt HC and unburnt CO are not generated. Particularly, when the turbines 61b and 62b are arranged in the exhaust passage 40 on the upstream of the oxidation catalyst 41a as in this embodiment, soot and HC become tarry by being mixed with each other and may attach to the turbines 61b and 62b; therefore, the injection amount of the after injections is desired to be set appropriately.

Here, because the fuel is more difficult to combust in a later after injection due to the decrease of the pressure inside the cylinder 11a, and in the after injections in the later stage of the entire after injections, if the injection amount is set to be the same as the after injections in the earlier stage, the possibility that unburnt HC and unburnt CO are generated increases. Therefore, as illustrated in FIG. 3, the PCM 10 reduces the injection amount to be less in the after injections in the later stage than that in the after injections in the earlier stage. In FIG. 3, the injection amount is the same in the first after injection and the second after injection, and the injection amount of the third after injection and thereafter is set below the injection amount of the first and second after injections and further becomes less toward the later after injection. Not limiting to this, for example, the injection amount may be set less toward the final after injection from the first after injection, and alternatively, the injection amount may be the same in a predetermined number of after injections starting from the first after injection (e.g., three) and the injection amount of the rest of the after injections may be the same thereamong and less than the injection amount of the predetermined number of after injections.

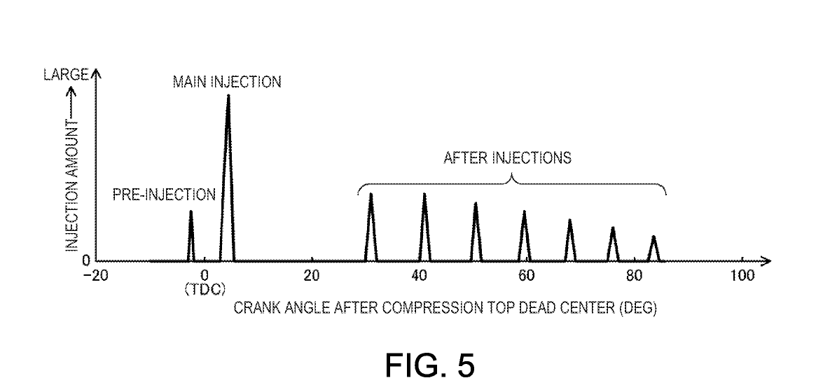

Moreover, because the fuel is more difficult to combust in the later after injection, if injection intervals between adjacent after injections in the later stage are the same as an injection interval between adjacent after injections in the early stage, even when the after injection in the later stage is performed, the fuel takes time to combust, and a possibility that the after combustion consecutive to the immediate previous after injection does not occur (unburnt fuel is left) increases. Thus, as illustrated in FIG. 5, for the after injections, the injection amount is preferably reduced to be less in the after injections in the later stage than the after injections in the earlier stage, and the injection time period is preferably shorter in the after injections in the later stage than the after injections in the earlier stage. In this manner, the fuel of each of the after injections including the after injections in the later stage is combusted at an appropriate timing to continue the combustion and, in association with the reduction of the injection amount, the generation of unburnt HC and unburnt CO can be suppressed effectively. In FIG. 5, an injection interval between the first and second after injections and an injection interval between the second and third after injections are the same, and injection intervals thereafter are shorter toward the later after injection. Due to such shortening of the injection interval, with the six after injections same as the case of FIG. 3, a timing at which the after combustion by the final after injection ends is earlier than in the case of FIG. 3. In view of increasing the exhaust gas temperature, the timing at which the after combustion by the final after injection ends is preferably as late as possible. Thus, in FIG. 5, a seventh after injection (an injection amount thereof is less than the sixth after injection) is added.

Note that, the injection amount may be fixed in the after injections and the injection intervals among the after injections in the later stage may be shorter than the injection intervals among the after injections in the earlier stage. Also by this, the fuel in each of the after injections including the after injections in the later stage can be completely combusted and the generation of unburnt HC and unburnt CO can be suppressed.

The engine speed when the oxidation catalyst 41a is in the deactivated state in an idling state is higher (e.g., 1500-2000 rpm) than the engine speed when the oxidation catalyst 41a is in the activated state in the idling state (same level as the engine speed in the idling state in a conventional diesel engine), and thus, the ignitability is improved and the exhaust gas temperature is further increased. Even if the engine speed in the idling state is increased, due to the reduced compression ratio, the level of vibrations and noises (so called NVH) is similar to the conventional diesel engine.

FIG. 6 illustrates a fuel injection mode in the idling state controlled by the PCM 10 when the oxidation catalyst 41a is in the activated state. In the idling state when the oxidation catalyst 41a is in the activated state (determined as the activated state based on the detected temperature from the exhaust gas temperature sensor SW8), the PCM 10 controls the injector 18 to perform a pilot injection, a plurality of pre-injections (two pre-injections in this embodiment), and a main injection. Because the oxidation catalyst 41a is in the activated state, the after injections in the deactivated state are not performed. In the idling state, although a comparatively large amount of fuel is required to be injected because the engine speed is low and the ignitability is poor, an injection of the large amount of fuel in one injection causes soot generation. Therefore, the fuel amount to be injected is divided. Note that, the pilot injection and the pre-injections are not essential and the pre-injections may be only once; however, when the compression ratio is reduced as in this embodiment, the fuel injection mode in FIG. 6 is preferred to secure a stable ignitability of the fuel in the main injection.

The pilot injection and the two pre-injections are performed sequentially before the CTDC. The pilot injection suppresses the soot generation by improving a premixing performance, and easily generates a pre-combustion by the first pre-injection. Moreover, the pre-combustion is generated by the fist pre-injection and the second pre-injection is performed so that a pre-combustion thereby is generated consecutively to the first pre-combustion. A relation between the second pre-injection and the main injection is similar to the relation between the pre-injection and the main injection when the oxidation catalyst 41a is in the deactivated state, and the main injection is performed at such a timing that a heat generation by the main injection starts after the heat release rate by the second pre-combustion passes the peak and before it reaches zero. Note that, because the after injection is not necessary, the timing at which the main injection is performed may be before the CTDC. In FIG. 6, although a major part of the injection period of the main injection is after the CTDC, the main injection starts immediately before the CTDC.

Further, when the oxidation catalyst 41a is in the activated state and not in the idling state, the fuel injection mode is set to be in accordance with the engine operating state, in which a pre-injection and a main injection are performed at least once each. The relation between the pre-injection and the main injection is similar to the relation between the second pre-injection and the main injection in the idling state.

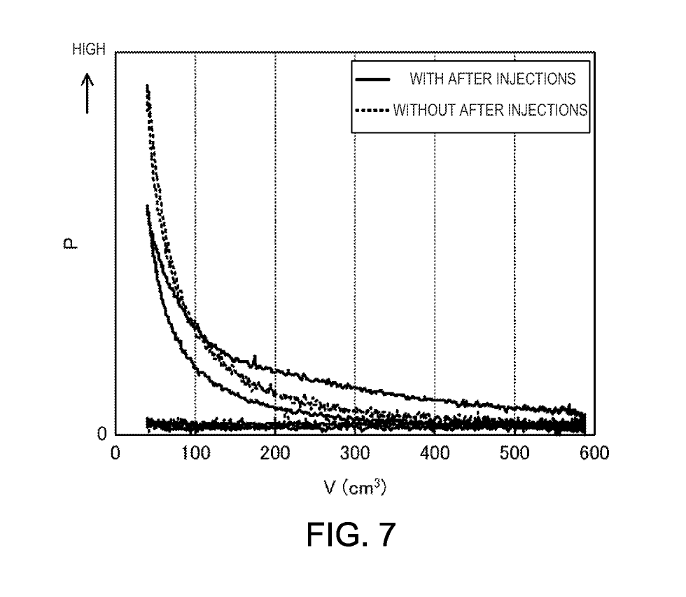

FIG. 7 is a P-V graph in the idling state of the engine 1 when the oxidation catalyst 41a is in the deactivated state (with after injections) and when the oxidation catalyst 41a is in the activated state (without after injections). “With after injections” indicates when the fuel is injected in the fuel injection mode in FIG. 3, and “without after injections” indicates when the fuel is injected in the fuel injection mode in FIG. 6. “With after injections,” the pressure during the compression and the maximum pressure (pressure at the CTDC) are lower than “without after injections” because the opening of the intake throttle valve 36 is smaller in “with after injections” than “without after injections,” causing a less of an intake air amount.

As seen from FIG. 7, “with after injections,” the pressure on the expansion stroke is increased because of the after combustions and the pressure at the end of the expansion stroke is also increased. This means that the exhaust gas temperature is increased.

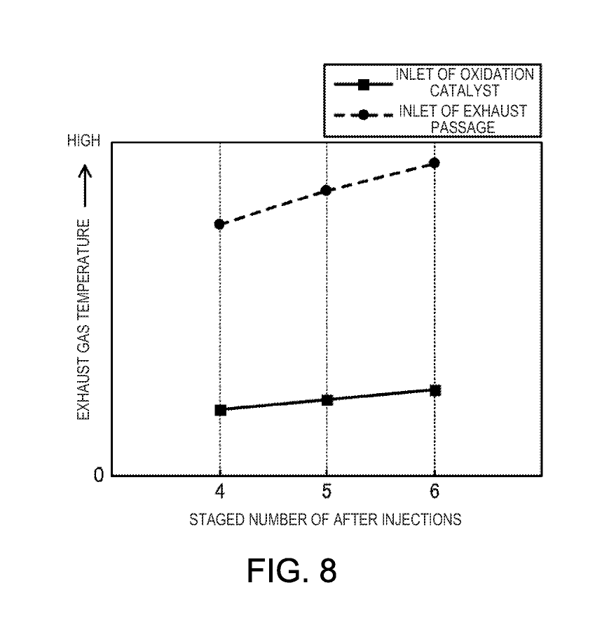

FIG. 8 illustrates a result of checking a relation in the engine 1, between a staged number of after injections (between four to six stages) with the exhaust gas temperature at an inlet of the exhaust passage 40 (immediately after the exhaust gas is discharged from the cylinder 11a) and the exhaust gas temperature at an inlet of the oxidation catalyst 41a. Here, each injection interval between the adjacent after injections is fixed, and even if the staged number of after injections is changed, the injection interval is the same. This means that the combustion lasts for a longer time period as the staged number is larger. Moreover, although an injection amount of a single injection is the same with any of four to six staged after injections, if the staged number of after injections is changed, the injection amount of a single injection changes. Note that, a total injection amount of all the after injections is the same even if the staged number changes. For example, with the four staged after injections, the injection amount of a single injection is ¼ of the total injection amount of all the after injections.

As seen from FIG. 8, the exhaust gas temperatures at the inlet of the exhaust passage 40 and the inlet of the oxidation catalyst 41a increase as the staged number of after injections is larger. Therefore, by setting the staged number of after injections to have the combustion that lasts as long as possible on the expansion stroke, the exhaust gas temperature can be increased as high as possible.

Note that, when two turbines 61a and 62b are arranged in the exhaust passage 40 upstream of the oxidation catalyst 41a as this embodiment, as seen from FIG. 8, the exhaust gas temperature at the inlet of the oxidation catalyst 41a is decreased significantly compared to the exhaust gas temperature at the inlet of the exhaust passage 40. This tendency is held similarly also when the number of turbines is one. Therefore, in diesel engines with turbochargers, the temperature of the oxidation catalyst 41a is difficult to be increased promptly unless the after injections as this embodiment are performed. Thus, the after injections of this embodiment are effective particularly in the diesel engines with turbochargers.

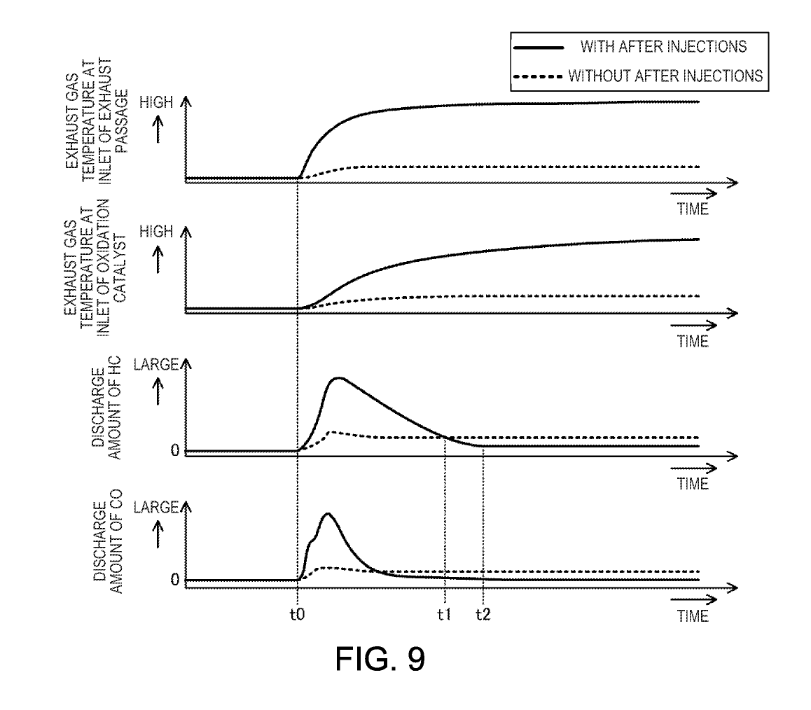

FIG. 9 illustrates a result of checking a change with time of the exhaust gas temperature at the inlet of the exhaust passage 40 (immediately after the exhaust gas is discharged from the cylinder 11a), the exhaust gas temperature at the inlet of the oxidation catalyst 41a, an HC discharge amount (discharge amount of HC to the atmosphere per unit of time), and a CO discharge amount (discharge amount of CO to the atmosphere per unit of time). The solid line indicates when the fuel is injected in the fuel injection mode in FIG. 3 “with after injections.” The broken line indicates when the fuel is injected in the fuel injection mode in FIG. 6 “without after injections.”

The engine 1 starts at a time point t0 and, thereby, the engine speed increases. “With after injections,” the engine speed increases to 1500-2000 rpm, and “without after injections,” it increases to about 800 rpm. Moreover, in the start of the engine 1, “with after injections,” the opening of the intake throttle valve 36 is below the predetermined opening, and “without after injections,” it is close to fully opened. Note that, the glow plug 19 is operated also “with after injections” same as “without after injections.”

“With after injections,” the exhaust gas temperatures at the inlet of the oxidation catalyst 40 and the inlet of the oxidation catalyst 41a increase compared to a case “without after injections.” Here, “with after injections,” because the injection amount of the after injections is slightly large, the unburnt fuel is left and the discharge amounts of HC and CO are temporarily larger than “without after injections” (the discharge amount of HC is particularly large). However, the oxidation catalyst 41a starts to be activated due to the increase in exhaust gas temperature and, therefore, the discharge amounts of HC and CO immediately decrease and, after a time point t1 (after approximately 35 seconds from the start of the engine 1), become less than “without after injections.” Note that, the discharge amount of CO becomes less than “without after injections” before the time point t1.

At a time point t2 (after approximately 45 seconds from the start of the engine 1), the oxidation catalyst 41a completely transitions to the activated state, and thereafter, the discharge amounts of HC and CO stabilize at a low level. On the one hand, “without after injections,” it takes a few minutes until the oxidation catalyst 41a transitions to the activated state. Therefore, considering the total discharge amounts of HC and CO from the start to the stop of the engine 1, the discharge amounts are less “with after injections.” Moreover, by appropriately setting the total injection amount of the after injections so as to suppress the unburnt fuel generation as much as possible, the discharge amounts of HC and CO can be further reduced.

Here, “with after injections” in FIG. 9, although the fuel injection mode in FIG. 3 continues even after the time point t2, actually, because the oxidation catalyst 41a is in the activated state, the fuel injection mode transitions to the one in FIG. 6 after the time point t2.

Note that, if the fuel injection mode transitions to the one in FIG. 6 immediately after the oxidation catalyst 41a becomes the activated state, the exhaust gas temperature decreases and the temperature of the oxidation catalyst 41a may decrease lower than the activating temperature. Thus, a post injection for supplying the unburnt fuel to the oxidation catalyst 41a on the expansion stroke or exhaust stroke after the main injection in the fuel injection mode in FIG. 6 (the pilot and main injections are not essential, and the number of pre-injections may be only once) may be performed for a predetermined time period from when the oxidation catalyst 41a becomes the activated state. Also in this case, because the oxidation catalyst 41a is already in the activated state, the discharge of HC and CO to the atmosphere can be suppressed, and the temperature of the activated oxidation catalyst 41a can be maintained at a temperature above the activating temperature by heat of an oxidizing reaction of the unburnt fuel caused by the activated oxidation catalyst 41a.

The post injection is performed also when the DPF 41b is regenerated, in other words, when a particulate amount captured by the DPF 41b increases and a difference between detected pressures from the upstream and downstream exhaust pressure sensors SW6 and SW7 reaches above a predetermined value, the post injection is performed to combust the captured particulates.

Therefore, in this embodiment, because the pre-injection, the main injection, and the plurality of after injections are performed when the oxidation catalyst 41a is in the deactivated state so that the combustion lasts until the middle stage of the expansion stroke, even if the geometric compression ratio is 15:1 or below, the temperature of the exhaust gas discharged from the cylinder 11a can be increased, and the oxidation catalyst 41a in the deactivated state can be activated promptly. As a result, the reduction in raw NOx can be achieved by the reduced compression ratio and the reduction in discharge amount of HC and CO to the atmosphere can be achieved by the oxidation catalyst 41a. Moreover, due to the reduction in raw NOx, the catalyst for purifying NOx becomes unnecessary. Further, particularly, by the pre-injection, the time length where fuel ignition is retarded for fuel from the main injection is stabilized and, thus, the timing at which the main combustion ends can be stabilized. In this manner, the timing of performing the first after injection is specified and the after combustion by the first after injection can surely be consecutive to the main combustion.

Moreover, by injecting the fuel into the cavity 14a in the main injection and the first after injection, the after combustion by the first after injection can surely be generated consecutively to the main combustion. Further, by performing the next after injection to generate the after combustion by this next after injection before the after combustion by the first after injection, even if the fuel is injected outside the cavity 14a in this next after injection, because the temperature inside the cylinder 11a is increased by the main combustion and the after combustion by the first after injection, the after combustion can continue consecutively to the after combustion by the first after injection by the next after injection, and the combustion can easily last until the middle stage of the expansion stroke.

Moreover, in the after injections, by reducing the injection amount to be less in the after injections in the later stage than in the after injections in the earlier stage, the fuel injected by the after injections in the later stage can completely be combusted and the generation of unburnt HC and unburnt CO can be suppressed. Therefore, when the oxidation catalyst 41a is in the deactivated state, the discharge amount of HC and CO to the atmosphere can be reduced.

Further, also by setting the injection interval shorter in the after injections in the later stage than the after injections in the earlier stage while fixing the injection amount stable in the after injections, the generation of unburnt HC and unburnt CO can be suppressed.

The present invention is not limited to this embodiment, and may be modified within the scope of not deviating from the spirit of the present invention.

For example, in this embodiment, the PCM 10 injects the fuel in the fuel injection mode of FIG. 3 (or FIG. 5) when the oxidation catalyst 41a is in the deactivated state; however, such a fuel injection mode can also be applied when the engine 1 in the cold state. In this manner, the engine 1 in the cold state can be transitioned to the warmed-up state promptly. In this case, when the engine 1 is transitioned to the warmed-up state (when the temperature of the engine coolant detected by the water temperature sensor SW1 exceeds the reference temperature), the fuel injection mode can be changed to the fuel injection mode of FIG. 6.

Moreover, in this embodiment, the geometric compression ratio of the engine 1 is 15:1 or below; however, not limiting to such a low compression ratio, a geometric compression ratio above 15:1 is also effective in prompt activation of the catalyst.

Further, in this embodiment, the PCM 10 controls the injector 18 to perform the pre-injection, the main injection, and the plurality of after injections when the oxidation catalyst 41a is in the deactivated state; however, the after injections are not essential. Also in this case, the ignition retardation period for fuel from the main injection can be stabilized as much as possible when the oxidation catalyst 41a is in the deactivated state (or when the engine 1 is in the cold state). Therefore, a suitable combustion can be obtained. Thus, by starting the main combustion near the CTDC, the combustion energy of the main combustion can efficiently be transmitted to the crankshaft 15 and, thus, a generated torque and fuel consumption can be improved.

Furthermore, in this embodiment, the engine 1 is the diesel engine with the turbochargers including the two turbochargers 61 and 62; however, it may be a diesel engine with one turbocharger or without any turbocharger.

The above-described embodiment is merely an illustration in all aspects of the present invention, and therefore, it must not be interpreted in a limited way. The scope of the present invention is defined by the following claims, and all of modifications and changes falling under the equivalent range of the claims are within the scope of the present invention.

The present invention is useful in fuel injection control devices of diesel engines and is particularly useful in diesel engines of which a geometric compression ratio is 15:1 or below and/or that have one or more turbochargers.

### DESCRIPTION OF REFERENCE NUMERALS

1 Diesel Engine (Engine Body)
10 PCM (Fuel Injection Control Module) (Temperature Calculating module)
11a Cylinder
14 Piston
14a Cavity
18 Injector (Fuel Injection Valve)
30 Intake Passage
40 Exhaust Passage
41a Oxidation Catalyst (Catalyst for Purifying HC)
61 Large Turbocharger
61a Compressor of Large Turbocharger
61b Turbine of Large Turbocharger
62 Small Turbocharger
62a Compressor of Small Turbocharger
62b Turbine of Small Turbocharger

1. A fuel injection control device of a diesel engine, comprising:
an engine body to be supplied with fuel mainly containing diesel fuel;
a fuel injection valve for injecting the fuel into a cylinder of the engine body;
a fuel injection control module for controlling the fuel injection by the fuel injection valve; and
a catalyst for purifying HC and provided in an exhaust passage through which exhaust gas is discharged from the cylinder,
wherein when the catalyst is in a deactivated state or the engine body is in a cold state, the fuel injection control module controls the fuel injection valve to perform a main injection for generating in the cylinder a main combustion mainly including a diffusion combustion, and a pre-injection for injecting the fuel before the main injection to generate a pre-combustion in the cylinder before the main combustion;
wherein the main injection is performed at such timing that a heat generation by the main combustion starts after a heat release rate caused by the pre-combustion passes its peak and before it reaches zero; and
wherein the pre-injection is performed at such timing before a top dead center on a compression stroke such that the main injection is performed after the compression top dead center.

2. The device of claim 1, wherein a geometric compression ratio of the engine body is 15:1 or below.

3. The device of claim 1, further comprising a temperature calculating module for calculating a temperature inside the cylinder at the compression top dead center, wherein the fuel injection control module increases an injection amount of the pre-injection or advances an injection timing of the pre-injection as the temperature calculated by the temperature calculating module is lower.

4. The device of claim 2, further comprising a temperature calculating module for calculating a temperature inside the cylinder at the compression top dead center, wherein the fuel injection control module increases an injection amount of the pre-injection or advances an injection timing of the pre-injection as the temperature calculated by the temperature calculating module is lower.

5. The device of claim 1, wherein when the catalyst is in the deactivated state, the fuel injection control module controls the fuel injection valve to perform, in addition to the pre-injection and the main injection, an after injection for injecting the fuel after the main injection to generate an after combustion in the cylinder consecutively to the main combustion.

6. The device of claim 2, wherein when the catalyst is in the deactivated state, the fuel injection control module controls the fuel injection valve to perform, in addition to the pre-injection and the main injection, an after injection for injecting the fuel after the main injection to generate an after combustion in the cylinder consecutively to the main combustion.

7. The device of claim 3, wherein when the catalyst is in the deactivated state, the fuel injection control module controls the fuel injection valve to perform, in addition to the pre-injection and the main injection, an after injection for injecting the fuel after the main injection to generate an after combustion in the cylinder consecutively to the main combustion.

8. The device of claim 4, wherein when the catalyst is in the deactivated state, the fuel injection control module controls the fuel injection valve to perform, in addition to the pre-injection and the main injection, an after injection for injecting the fuel after the main injection to generate an after combustion in the cylinder consecutively to the main combustion.

9. The device of claim 8, further comprising a turbocharger including a compressor arranged in an intake passage where an air intake into the cylinder is performed and a turbine arranged in the exhaust passage on an upstream side of the catalyst, to turbocharge intake air into the cylinder.

10. The device of claim 9, wherein the catalyst is an oxidation catalyst, and, for a predetermined period of time after the catalyst enters an activated state, the fuel injection control module controls the fuel injection valve to perform the main injection for generating in the cylinder the main combustion mainly including the diffusion combustion, and a post injection for injecting the fuel after the main injection to supply unburnt fuel to the catalyst.
